(19) United States
(12) Patent Application Publication
(10) Pub. No.: US 2025/0118725 A1
(43) Pub. Date: Apr. 10, 2025

(54) SOLID STATE BATTERY CELL MANUFACTURING

(71) Applicant: FORD GLOBAL TECHNOLOGIES, LLC, DEARBORN, MI (US)

(72) Inventors: Xin Liu, Novi, MI (US); Andrew Robert Drews, Ann Arbor, MI (US)

(21) Appl. No.: 18/481,633

(22) Filed: Oct. 5, 2023

(51) Int. Cl. H01M 4/04; H01M 10/0562; H01M 10/0587; H01M 50/46

(52) U.S. Cl. CPC H01M 4/043; H01M 10/0562; H01M 10/0587; H01M 50/46

(57) ABSTRACT

A method includes arranging a double sided positive electrode assembly between a pair of single sided negative electrodes assemblies such that positive electrode coatings of the double sided positive electrode assembly directly contact solid electrolyte separator layers of the single sided negative electrode assemblies to form a solid state electrode assembly, and applying pressure to each of the single sided negative electrode assemblies to compress the solid state electrode assembly and establish ionic contact between the positive electrode coatings and the solid electrolyte separator layers.

### TECHNICAL FIELD

This disclosure relates to battery manufacturing technology.

### BACKGROUND

Solid-state batteries are energy storage devices that differ from traditional lithium-ion batteries, which use liquid electrolytes. Solid-state batteries employ solid electrolytes, typically ceramics or solid polymers, to conduct ions between the battery's positive and negative electrodes.

### SUMMARY

A method for manufacturing a solid state battery cell includes arranging a double sided positive electrode assembly between a pair of single sided negative electrodes assemblies such that positive electrode coatings of the double sided positive electrode assembly directly contact solid electrolyte separator layers of the single sided negative electrode assemblies to form a solid state electrode assembly, and applying pressure to each of the single sided negative electrode assemblies to compress the solid state electrode assembly and establish ionic contact between the positive electrode coatings and the solid electrolyte separator layers to form a solid state battery cell with current collectors of the single sided negative electrode assemblies defining exterior surfaces of the solid state battery cell.

A method for manufacturing a plurality of solid state battery cells includes arranging a double sided positive electrode assembly, defining a plurality of positive tabs, between a pair of single sided negative electrodes assemblies, defining a plurality of negative tabs, such that positive electrode coatings of the double sided positive electrode assembly directly contact solid electrolyte separator layers of the single sided negative electrode assemblies to form a solid state electrode assembly, applying pressure to each of the single sided negative electrode assemblies to compress the solid state electrode assembly and establish ionic contact between the positive electrode coatings and the solid electrolyte separator layers to form an extended solid state battery preform, and cutting the extended solid state battery preform to form a plurality of solid state battery cells such that each of the plurality has one of the positive tabs and one of the negative tabs.

A method for manufacturing a plurality of solid state battery cells includes arranging a double sided positive electrode assembly, defining a plurality of positive tabs, between a pair of single sided negative electrodes assemblies, defining a plurality of negative tabs, such that positive electrode coatings of the double sided positive electrode assembly directly contact solid electrolyte separator layers of the single sided negative electrode assemblies to form a solid state electrode assembly, applying pressure to each of the single sided negative electrode assemblies to compress the solid state electrode assembly and establish ionic contact between the positive electrode coatings and the solid electrolyte separator layers to form an extended solid state battery preform, and winding the extended solid state battery preform to form a wound battery cell.

### BRIEF DESCRIPTION OF THE DRAWINGS

FIGS. 1 through 4 illustrate a cell design and process using a one-step multilayer calendaring process.

FIGS. 5 through 7 illustrate a similar one-step calendaring process as shown in FIGS. 1 through 4.

FIGS. 8 through 14 illustrate another method for manufacturing a solid state battery cell.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Typical lithium-ion battery processes involve coating electrode layers, stacking or winding electrodes with insulated separator film followed by filling with liquid electrolyte. An alternative is to use solid electrolyte in a solid state battery.

Solid state batteries could potentially provide electric vehicle battery solutions with higher energy densities compared to conventional lithium-ion batteries. When placing a solid electrolyte between an anode and cathode, it can physically separate the counter electrodes, which may eliminate the need for a separator and the subsequent electrolyte filling step. However, electrolyte in solid form faces challenges in contact resistance with its surrounding solid particles to complete filling the space between active materials. Traditional solid state battery assemblies require high area pressure or isostatic pressure to press multiple electrode and separator layers together. In order to have a higher production capacity for solid state batteries, an alternate manufacturing process may be needed.

Here, solid state battery cell designs are proposed that could be manufactured in a similar process as lithium-ion batteries while reducing contact resistance between solid particles. Particularly, this approach may leverage the high line pressure and roll-to-roll process during calendering to minimize the interfacial resistance between the electrode and solid electrolyte separator layer.

In certain lithium-ion battery designs, both cathode and anode are double side coated on current collectors. In one proposed design, one electrode is single side coated whereas the counter electrode is double side coated. A calendering step is used to press two single side coated electrodes and the double side coated electrode together, and remove porosities and gaps in and between electrodes. Before the calendering step, at least one of the electrodes may need to be laminated with the solid electrolyte layer. Either electrodes could be additionally calendered or not in a prior step.

The rolls of anode and cathode electrodes with or without solid electrolyte separator lamination could be notched or cut to a specific size. Three layers including two single coated layers and one double coated layer can be fed into a calender machine at room temperature or elevated temperature and pressed together by the calender rolls to form an A-B-A unit layer. The high line pressure of the calender machine continuously applied on the rolling electrodes allows removal of gap and porosities within this A-B-A unit layer, reducing the contact resistance within the unit. The A-B-A unit layer can then be wound up or stacked to multiple unit layers.

The proposed method could be applied to solid state battery cells with same size of anode, cathode, and separator. The reason is that in a lithium-ion battery cell, overhang of the anode may help prevent shorting due to the presence of ionically conductive electrolyte in areas outside the edges of electrodes leading to possible excessive deposition of lithium, whereas in solid state batteries the ionic path is only limited at the presence of solid electrolyte. By having all three layers of the cell be same, there is no ionic conduction pathway outside of the regions of direct contact between anodes, separator, and cathodes, and no local oversupply of lithium is possible. As an example, two layers of anode laminated with a separator and one layer of double side coated cathode having the same size can be calendered together, then cut to make individual units.

A possible advantage of having overhang is to lower the possibility of short circuiting at the electrode edge. The coated layers can be first notched to form tabs during calendering, then the three layers are pressed into one unit layer, and cut into individual units. A patterned coating on the double-sided coating layer can be used to allow the overhang design. Alternatively, the coated layers could be notched and cut to an individual electrode size, then pressed into one unit layer. The individual units are then stacked together to form a cell with multiple stacks.

In another example, both electrodes may be continuously coated and notched prior to the multilayer calendering step. After being pressed into a unit layer, the unit layer can be wound to form a prismatic cell or cylindrical cell. Because only metal to metal contact is involved in the stacking or winding process, no high pressure is required to form the solid electrolyte interface. Moreover, compared with alternative stacking with counter electrodes in certain pouch cell designs, the one unit stacking process removes the need of high precision alignment in the stacking process and may significantly cut the processing time. The process could also allow continuous calendering, cutting, and stacking.

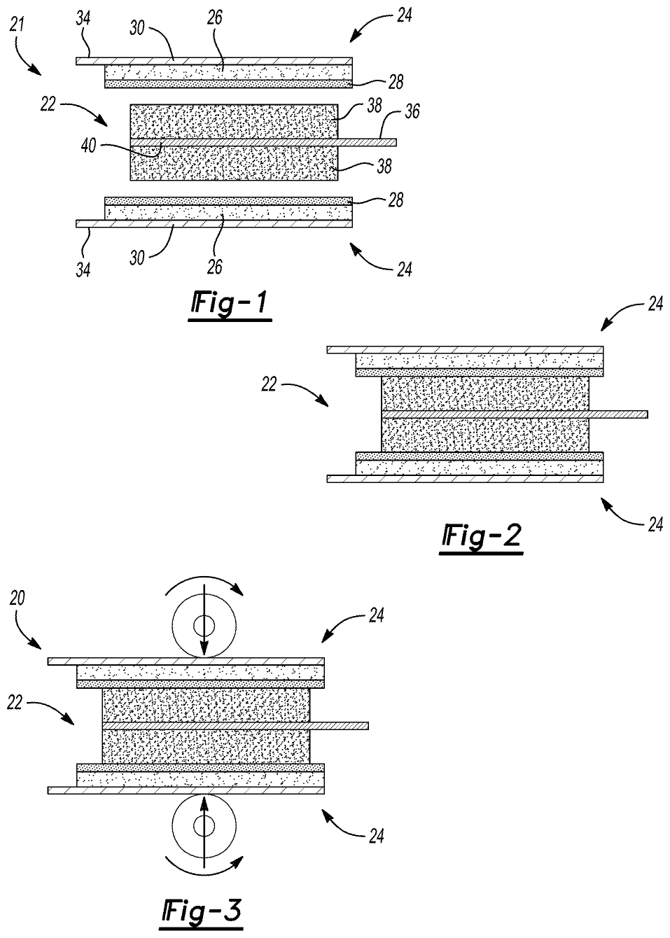

FIGS. 1-4 illustrate a cell design and process using a one-step multilayer calendaring process. FIGS. 1-4 illustrate a double sided positive electrode assembly 22 and a pair of single sided negative electrode assemblies 24. The double sided positive electrode assembly 22 is composed of a cathode coating 38 and a cathode current collector 40. The double sided positive electrode assembly 22 comprises two layers of the cathode coating 38, with the cathode current collector 40 in between the cathode coating 38. The double sided positive electrode assembly 22 further defines a positive tab 36. The single sided negative electrode assemblies 24 are composed of a positive coating 26, a solid electrolyte 28 and an anode current collector 30. In the single sided negative electrode assemblies 24, the positive coating 26 rests in between the solid electrolyte layer 28 and the anode current collector 30. The single sided negative electrode assemblies 24 further define a negative tab 34. According to an embodiment, at interfaces of the double sided positive electrode assembly 22 and the single sided negative electrode assemblies 24, facial areas of the electrode assemblies 22, 24 are the same. According to another embodiment, at interfaces of the double sided positive electrode assembly 22 and the single sided negative electrode assemblies 24, facial areas of the electrode assemblies 22, 24 are different.

Referring to FIG. 1, the double sided positive electrode assembly 22 is arranged between the pair of single sided negative electrode assemblies 24 such that the solid electrolyte layer 28 is in direct contact with the cathode coating 38 of the double sided positive electrode assembly 22 to form a solid state electrode assembly 21.

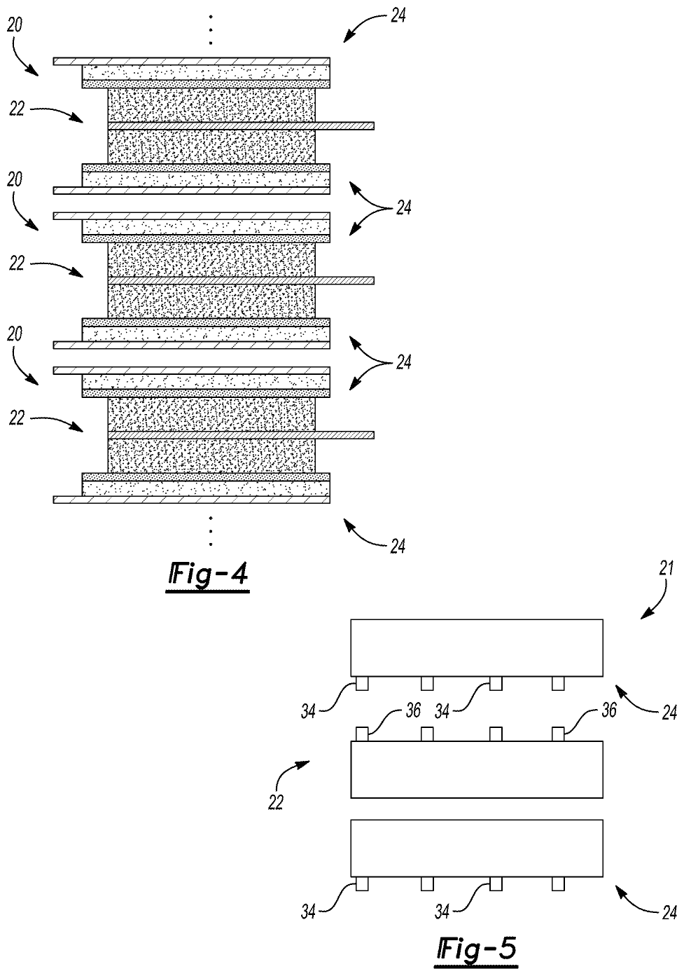

Referring to FIGS. 2 and 3, pressure is applied to each of the single sided negative electrode assemblies 24 to compress the solid state electrode assembly 21 and establish ionic contact between the positive electrode coating 26 and the solid electrolyte separator layers 28 to form a solid state battery cell 20. The pressure applied to each of the single sided negative electrode assemblies 24 is the calendaring step in the process to create the solid state battery cell 20. Applying pressure to the single sided negative electrode assemblies 24 removes porosities and gaps in and between any layers of the solid state electrode assembly 21. The anode current collector 30 of the single sided negative electrode assemblies 24 define exterior surfaces of the solid state battery cell 20. According to an embodiment when the facial areas of the double sided positive electrode assembly 22 and the single sided negative electrode assemblies 24 are different, the single sided negative electrode assembly 24 overhangs the double sided positive electrode assembly 22. In a solid state battery cell 20, the overhang of the single sided negative electrode assembly 24 may help prevent shorting due to the presence of ionically conductive electrolyte in areas outside the edges of electrodes, which could lead to possible excessive deposition of lithium-ion. FIG. 4 illustrates the completed solid state battery cell 20 after the calendaring process shown in FIGS. 1-3.

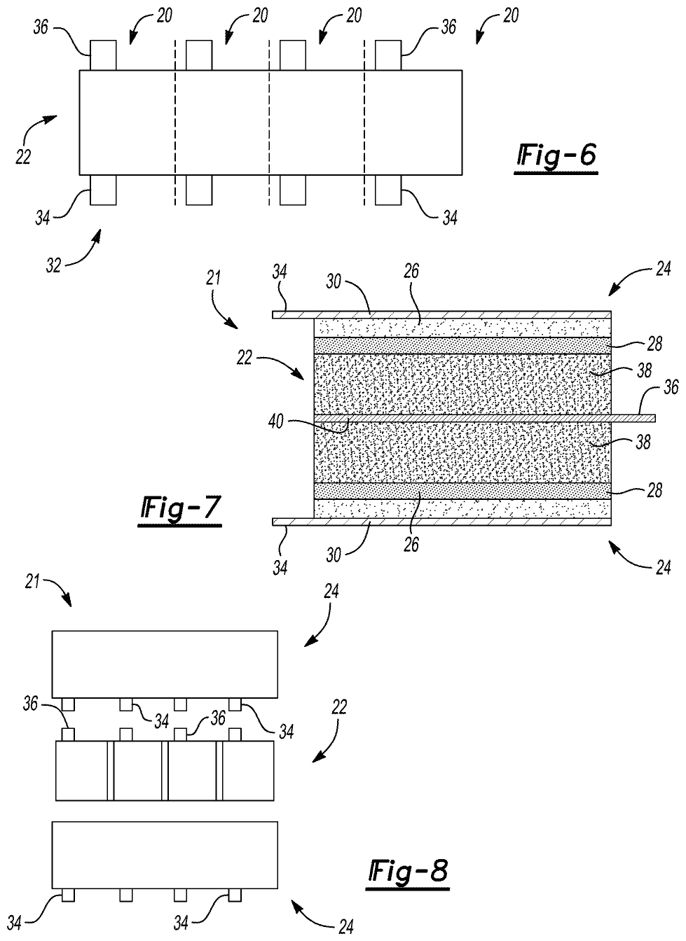

FIGS. 5-7 illustrate a similar one-step calendaring process as shown in FIGS. 1-4, but FIGS. 5-8 illustrate the process where the double sided positive electrode assembly 22 and the single sided negative electrode assembly 24 are the same size. FIG. 5 illustrates arranging the double sided positive electrode assembly 22 between the pair of single sided negative electrode assemblies 24. The double sided positive electrode assembly 22 defines the positive tab 36, and the single sided negative electrode assemblies 24 define a negative tab 34. The positive electrode coating 26 of the double sided positive electrode assembly 22 directly contacts the solid electrolyte separator layer 28 of the single sided negative electrode assemblies 24 to form the solid state electrode assembly 21. Once the electrode assemblies 22, 24 are arranged, pressure is applied to each of the single sided negative electrode assemblies 24 to compress the solid state electrode assembly 21. Applying pressure to compress the solid state electrode assembly 21 establishes ionic contact between the positive electrode coatings 26 and the solid electrolyte separator layers 28 to form an extended solid state battery preform 32, shown in FIG. 6. FIG. 6 also illustrates cutting the extended solid state battery preform 32 to form a plurality of solid state battery cells 20, such that each of the plurality of cells 20 has one of the positive tabs 36 and one of the negative tabs 34.

With continued reference to FIGS. 5-7, in one embodiment, interfaces of the double sided positive electrode assembly 22 and the single sided negative electrode assemblies 24 have facial areas that are the same for each of the solid state battery cells 20. In another embodiment, interfaces of the double sided positive electrode assembly 22 and the single sided negative electrode assemblies 24 have facial areas that are different for each of the solid state battery cells 20. In an embodiment where the facial areas are difference for each of the solid state battery cells 20, the single sided negative electrode assemblies 24 overhang the double sided positive electrode assembly 22.

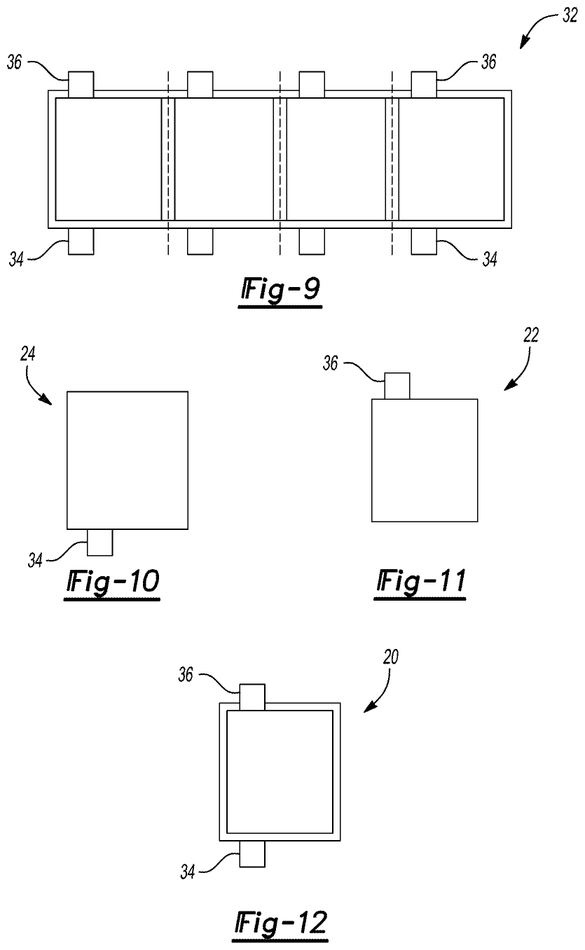

FIGS. 8-14 illustrate another method for manufacturing the solid state battery cell 20 with an arranging step, a pressurizing step, and a winding step. FIG. 8 illustrates arranging the double sided positive electrode assembly 22 between the pair of single sided negative electrode assemblies 24. The double sided positive electrode assembly 22 defines a plurality of positive tabs 36, and the single sided negative electrode assemblies 24 define a plurality of negative tabs 34. The positive electrode coating 26 of the double sided positive electrode assembly 22 directly contacts the solid electrolyte separator layer 28 of the single sided negative electrode assemblies 24 to form a solid state electrode assembly 21. Once the electrode assemblies 22, 24 are arranged, pressure is applied to each of the single sided negative electrode assemblies 24 (not shown). The pressure compresses the solid state electrode assembly 21 and establishes ionic contact between the positive electrode coatings 26 and the solid electrolyte separator layer 28 to form an extended solid state battery preform 32, shown in FIG. 9. The extended solid state battery preform 32 is then winded to form a wound battery cell. The wound battery cell can be a wound cylindrical battery cell or a wound prismatic cell.

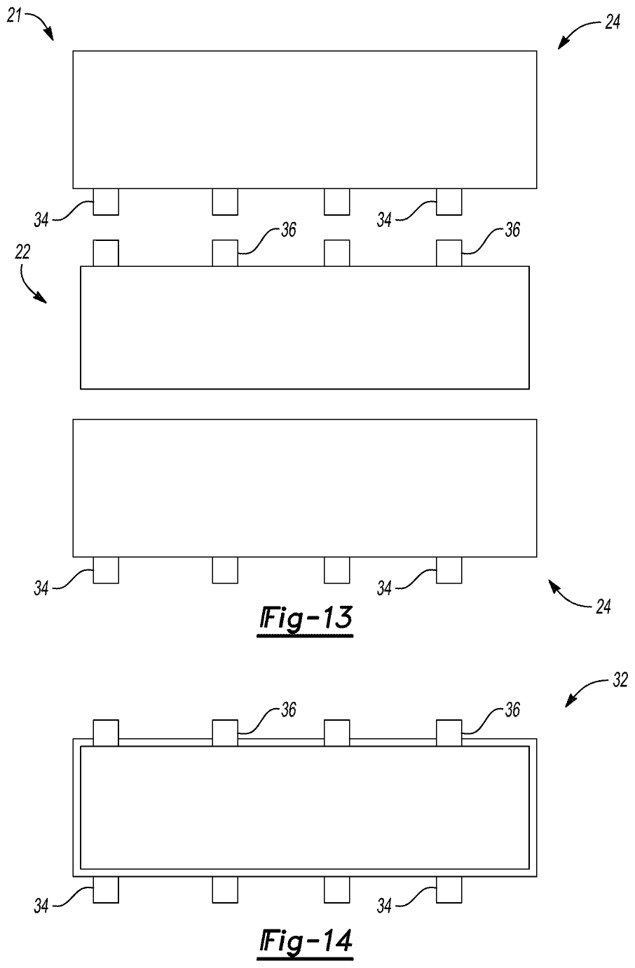

FIGS. 8-9 illustrate an embodiment where the electrode assemblies 22, 24 are notched to form the negative tab 34 and the positive tab 36 before the calendaring/pressurizing step. According to another embodiment, shown in FIGS. 10-12, the electrode assemblies 22, 24 could be notched and cut into individual electrode cells and then calendared/pressurized into the extended solid state battery preform 32. FIGS. 13-14 illustrate the electrode assemblies 22, 24 being continuously coated and notched prior to the multilayer calendaring step. During the winding process, only metal to metal contact is involved, thus, no high pressure is required to form solid electrolyte interface.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method for manufacturing a solid state battery cell, comprising:
arranging a double sided positive electrode assembly between a pair of single sided negative electrodes assemblies such that positive electrode coatings of the double sided positive electrode assembly directly contact solid electrolyte separator layers of the single sided negative electrode assemblies to form a solid state electrode assembly; and
applying pressure to each of the single sided negative electrode assemblies to compress the solid state electrode assembly and establish ionic contact between the positive electrode coatings and the solid electrolyte separator layers to form a solid state battery cell with current collectors of the single sided negative electrode assemblies defining exterior surfaces of the solid state battery cell.

2. The method of claim 1, wherein the double sided positive electrode assembly defines a positive tab and wherein each of the single sided negative electrode assemblies defines a negative tab.

3. The method of claim 1, wherein, at interfaces of the double sided positive electrode assembly and single sided negative electrode assemblies, facial areas of the double sided positive electrode assembly and single sided negative electrode assemblies are same.

4. The method of claim 1, wherein, at interfaces of the double sided positive electrode assembly and single sided negative electrode assemblies, facial areas of the double sided positive electrode assembly and single sided negative electrode assemblies are different.

5. The method of claim 4, wherein the facial areas are different such that the single sided negative electrode assemblies overhang the double sided positive electrode assembly.

6. A method for manufacturing a plurality of solid state battery cells, comprising:
arranging a double sided positive electrode assembly, defining a plurality of positive tabs, between a pair of single sided negative electrodes assemblies, defining a plurality of negative tabs, such that positive electrode coatings of the double sided positive electrode assembly directly contact solid electrolyte separator layers of the single sided negative electrode assemblies to form a solid state electrode assembly;
applying pressure to each of the single sided negative electrode assemblies to compress the solid state electrode assembly and establish ionic contact between the positive electrode coatings and the solid electrolyte separator layers to form an extended solid state battery preform; and
cutting the extended solid state battery preform to form a plurality of solid state battery cells such that each of the plurality has one of the positive tabs and one of the negative tabs.

7. The method of claim 6, wherein, at interfaces of the double sided positive electrode assembly and single sided negative electrode assemblies, facial areas of the double sided positive electrode assembly and single sided negative electrode assemblies are same for each of the solid state battery cells.

8. The method of claim 6, wherein, at interfaces of the double sided positive electrode assembly and single sided negative electrode assemblies, facial areas of the double sided positive electrode assembly and single sided negative electrode assemblies are different for each of the solid state battery cells.

9. The method of claim 8, wherein the facial areas are different such that the single sided negative electrode assemblies overhang the double sided positive electrode assembly for each of the solid state battery cells.

10. A method for manufacturing a plurality of solid state battery cells, comprising:
arranging a double sided positive electrode assembly, defining a plurality of positive tabs, between a pair of single sided negative electrodes assemblies, defining a plurality of negative tabs, such that positive electrode coatings of the double sided positive electrode assembly directly contact solid electrolyte separator layers of the single sided negative electrode assemblies to form a solid state electrode assembly;
applying pressure to each of the single sided negative electrode assemblies to compress the solid state electrode assembly and establish ionic contact between the positive electrode coatings and the solid electrolyte separator layers to form an extended solid state battery preform; and
winding the extended solid state battery preform to form a wound battery cell.

11. The method of claim 10, wherein, at interfaces of the double sided positive electrode assembly and single sided negative electrode assemblies, facial areas of the double sided positive electrode assembly and single sided negative electrode assemblies are same for each of the solid state battery cells.

12. The method of claim 10, wherein, at interfaces of the double sided positive electrode assembly and single sided negative electrode assemblies, facial areas of the double sided positive electrode assembly and single sided negative electrode assemblies are different for each of the solid state battery cells.

13. The method of claim 12, wherein the facial areas are different such that the single sided negative electrode assemblies overhang the double sided positive electrode assembly for each of the solid state battery cells.

14. The method of claim 10, wherein the wound battery cell is a wound cylindrical battery cell.

15. The method of claim 10, wherein the wound battery cell is a wound prismatic battery cell.
